(19) United States
(12) Patent Application Publication
(10) Pub. No.: US 2018/0252128 A1
(43) Pub. Date: Sep. 6, 2018

(54) DEVICE FOR AN ENGINE COMPRISING AN OIL PAN AND A HEAT EXCHANGER

(71) Applicant: NOVARES France, CLAMART (FR)

(72) Inventors: Vincent ROSSIGNOL, LYON (FR); Gilles WAYMEL, HULLUCH (FR); Jérôme Jérôme, CALONNE SUR LA LYS (FR)

(21) Appl. No.: 15/760,149

(22) PCT Filed: Sep. 14, 2016
(86) PCT No.: PCT/FR2016/052315

§ 371 Date: Mar. 14, 2018

(30) Foreign Application Priority Data
Sep. 17, 2015 (FR) 15/58767

(51) Int. Cl. F01M 5/00; F28D 9/00; F28F 21/02; F28F 21/06; B29C 65/14; B29C 65/00; F01M 11/00

(52) U.S. Cl. CPC F01M 5/002; F28D 9/005; F28F 21/02; F28F 21/065; B29C 65/1477; F28D 2021/0089; B29C 66/114; B29C 66/242; B29C 66/244; B29C 66/543; F01M 11/0004; B29C 66/71

(57) ABSTRACT

The invention relates to a device (1) for an engine which includes an oil pan (2) made of a plastic material having a hollow shape (21) containing lubricating oil defined by a bottom wall (22), a plurality of side walls (24) and upper edges (25). The oil pan (2) has at least one exchanger surface (30) which comprises means for circulating oil and means for circulating a coolant, and a heat exchanger (4) in which oil and a coolant circulate, comprising a series of plates (41) made of a plastic material welded together two-by-two and welded to the exchanger surface (30).

### CROSS REFERENCE TO RELATED APPLICATIONS

This application is a National Stage of PCT Application No. PCT/FR2016/052315 filed on Sep. 14, 2016, which claims priority to French Patent Application No. 15/58767 filed on Sep. 17, 2015, the contents each of which are incorporated herein by reference thereto.

### TECHNICAL FIELD

The invention concerns an engine device comprising an oil pan and a heat exchanger.

### BACKGROUND

In the automotive industry, it is known to use a water-oil heat exchanger for regulating the temperature of the engine oil.

Thus, the water-oil heat exchanger can allow accelerating the rise in temperature of the engine oil and can also allow cooling the engine oil.

Indeed, when starting a motor vehicle, the water present in the cooling circuit heats up very rapidly, while the oil of the engine experiences a slower rise in temperature. However, the engine cannot operate fully as long as the oil has not reached the right temperature.

In order to accelerate the heating of the oil, it is known to use a water-oil heat exchanger. The heat exchanger has usually a stack of water and oil circuits in close contact in order to allow a heat transmission from water to oil.

After the recent developments, the oil pans can be made of plastic material, while the heat exchangers are made of aluminum. Aluminum has the advantage of transferring heat and thus of facilitating the heat exchanges between water and oil.

However, the assembly of the aluminum heat exchanger on the plastic oil pan involves the use of seals and requires bolt-fastening, which increases: the number of manufacturing operations, the assemblies and therefore the cost.

Accordingly, the present invention aims to provide an engine device which can be assembled with a reduced number of manufacturing operations.

### BRIEF SUMMARY

According to a general definition, the invention concerns an engine device which comprises a plastic oil pan having a hollow shape and containing lubricating oil delimited by a bottom wall, several side walls and upper flanges. The oil pan has at least one exchanger surface which comprises oil circulation means and cooling liquid circulation means, and a heat exchanger in which oil and a cooling liquid circulate, comprising a series of plastic material plates welded in pairs and welded onto the exchanger surface.

Thus, the invention provides an engine device which comprises an oil pan and a heat exchanger made of plastic material. The assembly of the heat exchanger on the oil pan is performed by welding and allows eliminating the use of a seal. The invention therefore proposes an engine device that can be assembled with a reduced number of manufacturing operations.

In addition, the presence of an exchanger surface on the oil pan allows maximizing the tightness of the connection between the oil pan and the heat exchanger.

The exchanger surface can be molded integrally with the oil pan.

This technical arrangement allows reducing the number of operations of manufacturing the device.

According to another embodiment, the exchanger surface can be positioned on one of the side walls of the oil pan.

According to an embodiment, the exchanger surface can be positioned on one of the upper flanges of the oil pan.

The plates of the heat exchanger may be made of polyamide comprising between 30% and 60% of an additive belonging to the group comprising graphite and carbon.

Advantageously, the addition of graphite or carbon in the polyamide allows increasing the heat transfer capacity of the heat exchanger.

The oil pan can be made of polyamide.

A first exchange area of each plate may have a plurality of protrusions configured to cooperate with cavities of a corresponding second exchange area of a contiguous plate.

The series of plates of the heat exchanger may comprise oil flow plates having oil flow means on the first exchange area of the oil flow plate, and cooling liquid flow plates having cooling liquid flow means on the first exchange area of the cooling liquid flow plate.

The exchanger surface can be surrounded by a joining rib.

Each plate of the heat exchanger can be surrounded by a joining rib.

The joining ribs of the exchange surface and of each plate of the heat exchanger can be configured to be welded in pairs.

The heat exchanger may comprise a closure plate welded to the series of plates of the heat exchanger.

The plates of the heat exchanger can be welded by electromagnetic induction.

The series of plates of the heat exchanger can be welded to the exchanger surface by electromagnetic induction.

According to a particular arrangement, at least one of the plates may have a thickness different from the thickness of the other plates of the heat exchanger.

The oil pan may comprise at least one receptacle configured to receive an oil filter.

At least one side wall of the oil pan may have an opening near the bottom wall, the opening being configured to receive a drain plug.

### BRIEF DESCRIPTION OF THE DRAWINGS

Other features and advantages of the invention will emerge from the following description, with reference to the appended drawings that show two embodiments of the invention.

FIG. 1 is an exploded perspective view of the invention according to a first embodiment;

FIG. 2 is an exploded perspective view of the invention according to a second embodiment;

FIG. 3 is an exploded perspective view of a series of plates of a heat exchanger according to a second embodiment of the invention.

### DETAILED DESCRIPTION

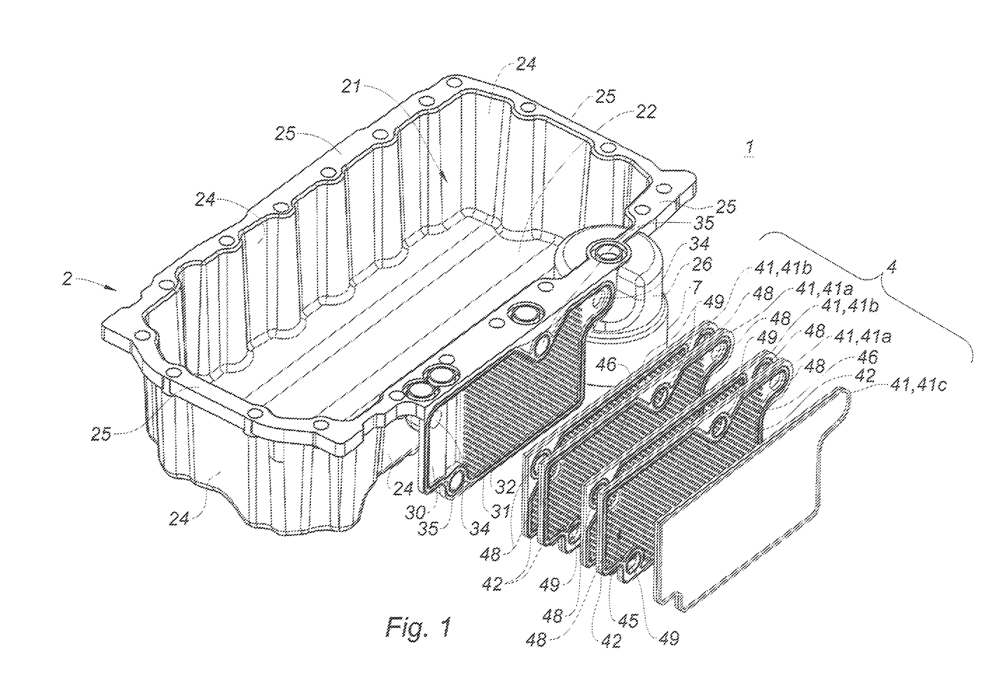

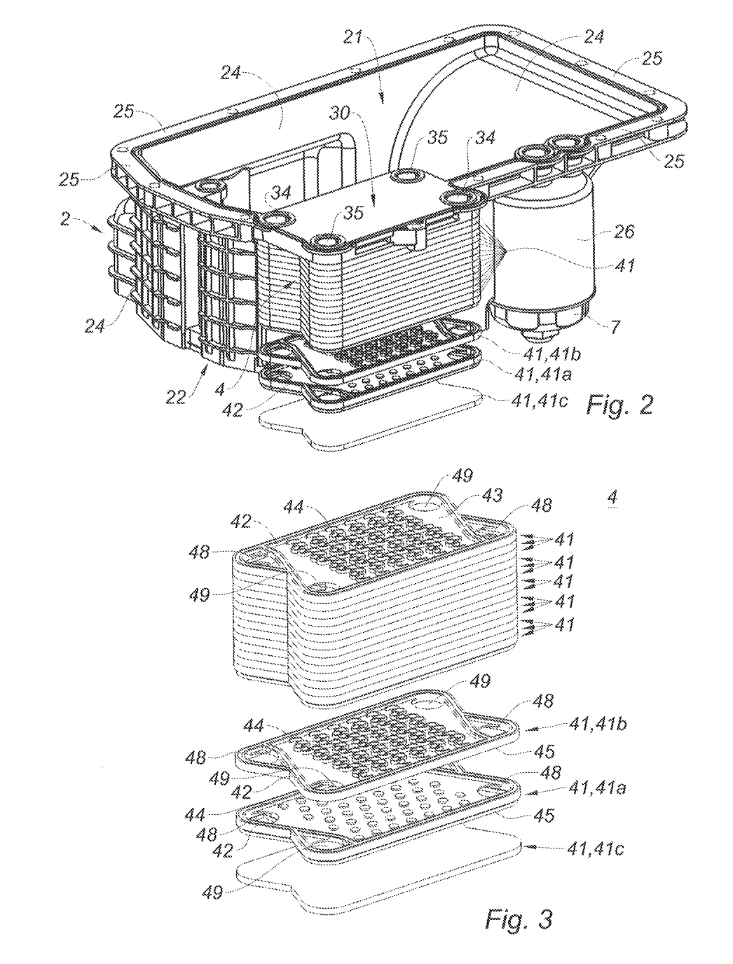

With reference to FIGS. 1 and 2, the invention concerns an engine device 1 which comprises an oil pan 2 and a heat exchanger 4.

The oil pan 2 is made of plastic material, according to the examples shown herein, the oil pan 2 can be made of molded polyamide.

The oil pan 2 has a hollow shape 21 containing lubricating oil delimited by a bottom wall 22, several side walls 24, upper flanges 25.

In general, the oil pan 2 may have a receptacle 26 configured to receive an oil filter 7.

Furthermore, the oil pan 2 has an exchanger surface 30.

According to the first embodiment, shown in FIG. 1, the exchanger surface 30 is positioned on a side wall 24 of the oil pan 2.

In a particularly advantageous manner, the exchanger surface 30 is integrally molded with the oil pan 2.

The exchanger surface 30 comprises oil circulation means and cooling liquid circulation means.

The oil circulation means comprise oil circulation orifices 34.

The cooling liquid circulation means comprise cooling liquid circulation orifices 35.

In addition, the exchanger surface 30 has an array of cavities 31 that allows distributing the fluid over the entire exchanger surface 30, so as to maximize the heat exchanges.

The exchanger surface 30 is surrounded by a joining rib 32 whose function will be detailed later.

A second embodiment of the device 1 can be appreciated through FIG. 2. It is specified that for simplification reasons, the elements that have the same function, in both embodiments, have the same reference.

According to the second embodiment, the exchanger surface 30 is positioned on an upper flange 25.

The heat exchanger 4 is shown in FIGS. 1 to 3. As can be seen, the heat exchanger 4 comprises a series of plates 41.

Each plate 41 has oil circulation means and cooling liquid circulation means.

The oil circulation means comprise oil circulation orifices 48.

The cooling liquid circulation means comprise cooling liquid circulation orifices 49.

Each plate 41 is surrounded by a joining rib 42 whose function will be detailed below.

Each plate 41 has a first exchange area 43 which has a plurality of protrusions 44. In addition, each plate 41 has a second exchange area 45 which has a plurality of cavities 46.

The protrusions 44 of each plate 41 are configured to cooperate with the cavities 46 of another adjacent plate 41 or with the cavities 31 of the exchanger surface 30.

In a particularly advantageous manner, the protrusions 44 and the cavities 46 each have an adapted geometry for optimizing the heat exchanges.

The series of plates 41 comprises oil flow plates 41a and cooling liquid flow plates 41b.

The oil flow plates 41a have oil flow means on the first exchange area 43 of the oil flow plate 41a.

The cooling liquid flow plates 41b have oil flow means on the first exchange area 43 of the oil flow plate 41b.

As seen in particular in FIG. 3, the protrusions 44 of the oil flow plates 41a may have a geometry different from the protrusions 44 of the cooling liquid flow plates 41b.

According to a particular arrangement, one of the plates 41 may have a thickness different from the thickness of the other plates 41 of the heat exchanger 4.

As can be seen, the series of plates 41 may further comprise a closure plate 41c. The closure plate 41c may have substantially smooth or ribbed faces. The closure plate 41c is positioned at the free end of the series of plates 41.

In a particularly advantageous manner, the plates 41 are made of polyamide comprising between 30% and 60% of a filler that allows increasing the heat exchange capacity of the plates 41. The filler may, for example, comprise graphite or carbon.

In use, the joining ribs 42 of each plate 41 are welded in pairs. In addition, the joining rib 42 of the plate 41 adjacent to the exchanger surface 30 is welded to the joining rib 32 of the exchanger surface 30.

According to a particular arrangement, the welds are made by electromagnetic induction.

As seen in the figures, an engine device devoid of seal is thus obtained since the weld of the filled polyamide heat exchanger on the polyamide oil pan ensures the tightness of the device. In addition, the use of an oil pan and of a heat exchanger made of polyamide allows to shorten the method for manufacturing the engine device.

Of course, the invention is not restricted to the sole embodiments shown above, but it encompasses on the contrary all the embodiments.

1. An engine device characterized in that it comprises an oil pan made of plastic material having a hollow shape containing lubricating oil delimited by a bottom wall, several side walls and upper flanges, the oil pan having at least one exchanger surface that comprises oil circulation means and cooling liquid circulation means, and a heat exchanger in which oil and a cooling liquid circulate, comprising a series of plastic material plates welded in pairs and welded onto the exchanger surface.

2. The device according to claim 1 characterized in that the exchanger surface is integrally molded with the oil pan.

3. The device according to claim 1, characterized in that the exchanger surface is positioned on one of the side walls of the oil pan.

4. The device according to claim 1, characterized in that the exchanger surface is positioned on one of the upper flanges of the oil pan.

5. The device according to claim 1, characterized in that the plates of the heat exchanger are made of polyamide comprising between 30% and 60% of an additive belonging to the group comprising graphite and carbon.

6. The device according to claim 1, characterized in that the oil pan is made of polyamide.

7. The device according to claim 1, characterized in that a first exchange area of each plate has a plurality of protrusions configured to cooperate with the cavities of a corresponding second exchange area (45) of a contiguous plate.

8. The device according to claim 7, characterized in that the series of plates of the heat exchanger comprises oil flow plates having oil flow means on the first exchange area of the oil flow plate, and cooling liquid flow plates having cooling liquid flow means on the first exchange area of the cooling liquid flow plate.

9. The device according to claim 1, characterized in that the exchanger surface is surrounded by a joining rib.

10. The device according to claim 1, characterized in that each plate of the heat exchanger is surrounded by a joining rib.

11. The device according to claim 9, characterized in that the joining ribs of the exchange surface and of each plate of the heat exchanger are configured to be welded in pairs.

12. The device according to claim 1, characterized in that the heat exchanger comprises a closure plate welded to the series of plates of the heat exchanger.

13. The device according to claim 1, characterized in that the plates of the heat exchanger are welded by electromagnetic induction.

14. The device according to claim 1, characterized in that the series of plates of the heat exchanger is welded to the exchanger surface by electromagnetic induction.

15. The device according to claim 1, characterized in that at least one of the plates can have a thickness different from the thickness of the other plates of the heat exchanger.

16. The device according to claim 1, characterized in that the oil pan comprises at least one receptacle configured to receive an oil filter.

17. The device according to claim 2, characterized in that the exchanger surface is positioned on one of the side walls of the oil pan.

18. The device according to claim 2, characterized in that the exchanger surface is positioned on one of the upper flanges of the oil pan.

19. The device according to claim 2, characterized in that the plates of the heat exchanger are made of polyamide comprising between 30% and 60% of an additive belonging to the group comprising graphite and carbon.

20. The device according to claim 2, characterized in that a first exchange area of each plate has a plurality of protrusions configured to cooperate with the cavities of a corresponding second exchange area (45) of a contiguous plate.
